(19) United States
(12) Patent Application Publication
(10) Pub. No.: US 2003/0120534 A1
(43) Pub. Date: Jun. 26, 2003

(54) Cosmetic affinity indexing

(76) Inventors: Daniela Giacchetti, Paris (FR); Beatrice Pardi, Milano (IT); Gilles Rubinstenn, Paris (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,356

(22) Filed: Dec. 21, 2001

(51) Int. Cl. G06F 17/60

(52) U.S. Cl. 705/10

(57) ABSTRACT

Methods and systems are disclosed for helping a consumer make a cosmetic product purchasing decision. A cosmetic service may maintain information reflective of compatibility between cosmetic products and personal characteristics of a plurality of subjects. The cosmetic service may also collect personal characteristic information from the consumer and compare the consumer's collected personal characteristic information with the maintained compatibility information. Based on the comparison, the cosmetic service may determine a compatibility level of the consumer with each of a plurality of the cosmetic products. Thereafter, the cosmetic service may present to the consumer an indication of a cosmetic product, and associate with the presented product, an indicator of predicted compatibility with the consumer.

### BACKGROUND OF THE INVENTION

1. Field of the Invention

The present invention relates generally to data processing systems and, more particularly, to systems and methods for helping consumers select cosmetic products having predicted compatibility with personal characteristics of the consumer.

2. Description of Related Art

Consumers interested in making informed decisions about cosmetic product purchases may be faced with a daunting task. Large numbers of cosmetic manufacturers offer for sale what consumers may perceive as an infinite number of cosmetic products, many of which are sold with similar claims of effectiveness. As a result, many consumers rely upon trial and error to select cosmetic products. This manner of trial and error often results in consumers spending a considerable amount of time and money identifying cosmetic products that work best with their particular body chemistry or are most compatible with their physical features.

Consumers might use price as a gauge of perceived effectiveness, purchasing more costly products in hopes that the cost corresponds to the degree of effectiveness. While this may be true in some instances, physical characteristics of the consumer may be an important factor in choosing a most effective product.

Consumers who use a product (e.g., merchandise or service) from a particular class of cosmetic products and are dissatisfied with the effectiveness of the product, may shy away from thereafter using any other product in the class. From the manufacturer's perspective, this phenomenon may translate into lost sales. Indeed, even within a manufacturer's own product line there may exist multiple products for treating the same condition. Each product may work differently on a particular consumer. From the manufacturer's perspective, it would be most advantageous for consumers to use the product with which they are most compatible. This may be the best way of ensuring repeat business.

From the consumer's perspective, even if an effective product is available, the consumer may become discouraged before locating it and may never realize the benefits of the product.

### SUMMARY OF A FEW ASPECTS OF THE INVENTION

Methods, combinations, apparatus, systems, and articles of manufacture consistent with the features and principles of the present invention help a consumer make a cosmetic product purchasing decision.

According to one exemplary aspect of the present invention, a method of helping a consumer make a cosmetic product purchasing decision may include maintaining information reflective of compatibility between cosmetic products and personal characteristics of a plurality of subjects. Personal characteristic information from the consumer may also be collected. The consumer's collected personal characteristic information may then be compared with the maintained compatibility information. Based on the comparing, a compatibility level of the consumer with each of a plurality of the cosmetic products may be determined. Thereafter, an indication of at least one of the plurality of cosmetic products may be presented to the consumer, and an indicator of predicted compatibility between the at least one presented product and the consumer may be associated with the at least one presented product. An indicator associated with the at least one presented product may be numeric, graphical, or symbolic, and may be displayed in a manner to permit the consumer to ascertain the relative compatibility of multiple products.

Personal characteristic information of a subject may include at least one of physical characteristics, lifestyle information, and family history information. Personal characteristic information of a consumer may also include at least one of physical characteristics, lifestyle information, and family history information.

Another exemplary aspect may further include prompting the consumer to select at least one category or brand of cosmetic product. Accordingly, a plurality of listed cosmetic products including the at least one presented product may be selected to fall within the at least one category or brand.

Another exemplary aspect may include a method of classifying cosmetic products. The method may include maintaining in a data structure information based on the use of a plurality of cosmetic products by a plurality of subjects having varying personal characteristics, maintaining in the data structure information reflective of at least some of the personal characteristics of the subjects, and maintaining in the data structure information reflective of a degree of compatibility between at least some of the cosmetic products and the personal characteristics of at least some of the subjects. The method may further include prompting a consumer to provide personal information reflective of the consumer's own personal characteristics, comparing the personal information provided by the consumer with the personal characteristics information contained in the data structure, and causing at least some of the plurality of cosmetic products to be classified by a predicted degree of compatibility with the consumer.

Additional aspects of the invention are set forth in the description which follow and, in part, are obvious from the description, or may be learned by practice of methods, combinations, devices, systems, and articles of manufacturer consistent with features of the present invention. The aspects of the invention may be realized and attained by means of the elements and combinations particularly pointed out in the appended claims. It is understood that both the foregoing description and the following detailed description are exemplary and explanatory only and are not restrictive of the invention as claimed.

### BRIEF DESCRIPTION OF THE DRAWINGS

FIG. 1 is an exemplary flowchart of a method for helping a consumer make a cosmetic product purchasing decision consistent with the present invention;

FIG. 2 is an exemplary flowchart of a method for collecting personal information from subjects consistent with the present invention;

FIG. 3 is a first example of a display of results provided to a consumer by a cosmetic service consistent with the present invention;

FIG. 4 is a diagram of an exemplary network environment in which the features and aspects of the present invention may be implemented;

FIG. 5 is an exemplary diagram of a cosmetic service system consistent with the present invention;

FIG. 6 is an exemplary diagram of a server configuration consistent with the present invention;

FIG. 7 is another exemplary flowchart of a method for helping a consumer make a cosmetic product purchasing decision consistent with the present invention;

FIG. 8 is a second example of a display of results provided to a consumer by a cosmetic service consistent with the present invention;

FIG. 9 is a third example of a display of results provided to a consumer by a cosmetic service consistent with the present invention; and

FIG. 10 is an example of a browser display consistent with the present invention.

### DESCRIPTION OF EXEMPLARY EMBODIMENTS

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

Methods and systems consistent with the principles of the invention may help a consumer make a cosmetic product purchasing decision. To this end, a cosmetic service may maintain information reflective of compatibility between cosmetic products and personal characteristics of a plurality of subjects.

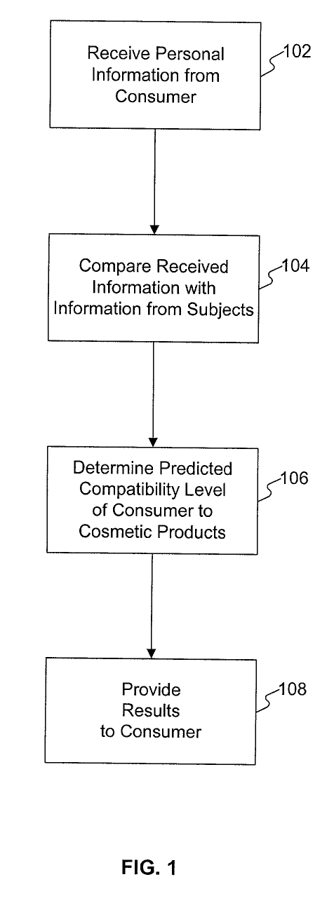

FIG. 1 is an exemplary flowchart of a method for helping a consumer make a cosmetic product purchasing decision consistent with the present invention. As with all the flowcharts presented herein, FIG. 1 is exemplary. Thus, while the steps of the flowchart are described in a particular order, one skilled in the art will appreciate that these steps may be performed in a different order, or that some of the steps may be concurrent.

The cosmetic service may receive personal characteristic information from the consumer (step 102) and compare the consumer's collected personal characteristic information with the maintained compatibility information (step 104). Personal characteristic information of the consumer may also include at least one of physical characteristics, lifestyle information, and family information.

Based on the comparison, the cosmetic service may determine a compatibility level of the consumer with one or more cosmetic products (step 106). Thereafter, the cosmetic service may present results to the consumer (step 108). The results may include any form of indication of compatibility between at least one cosmetic product and the consumer. Indicators of predicted compatibility may include numeric indicators, symbolic indicators, and/or graphical indicators. One or more of these types of indicators may be presented to the consumer to help the consumer ascertain the relative predicted compatibility of cosmetic products to the consumer.

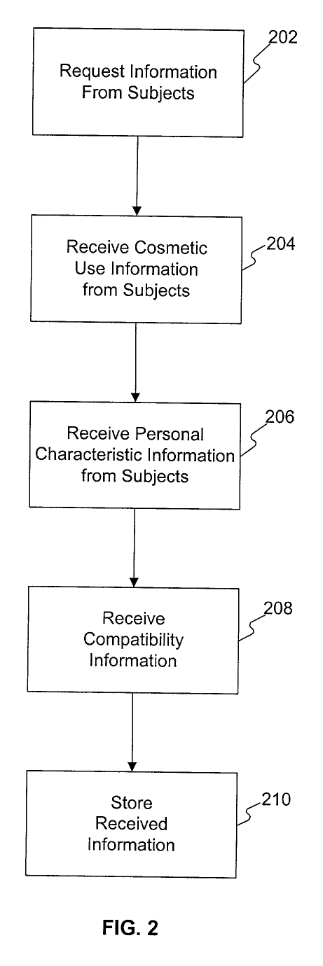

FIG. 2 is an exemplary flowchart of a method for collecting personal information from subjects consistent with the present invention. First, a cosmetic service may request various items of information from a plurality of subjects (step 202). For example, a cosmetic service or an agent of the cosmetic service may send an electronic or paper survey to one or more subjects. This survey may ask the subjects to provide one or more of information reflective of the use of a plurality of cosmetic products by the subjects (cosmetic use information), information reflective of personal characteristics of the subjects, and information reflective of a degree of compatibility between at least some of the cosmetic products and the personal characteristics of the subjects (subject compatibility information).

Once a subject has completed the survey, the subject may return the completed survey to the cosmetic service or otherwise inform the cosmetic service of the responses to the survey (e.g., electronically, physically, or through telephone interaction with an agent of the cosmetic service). After, the cosmetic service receives the cosmetic use information, personal characteristic information, and the compatibility information from the subjects (steps 204, 206, and 208), the received information may be stored for later use by the cosmetic service (step 210). For example, a server located at the cosmetic service may receive completed electronic surveys from subjects via a network. The cosmetic use information, personal characteristic information, and compatibility information from those surveys may be stored in memory and then forwarded to a subject information database for longer storage. Alternatively, the cosmetic service may receive completed electronic or paper surveys and store the information from those surveys directly in the subject information database without storage in memory. In addition, instead of receiving subject information based on a survey of subjects, the cosmetic service may gather the information from those with knowledge of the cosmetic field.

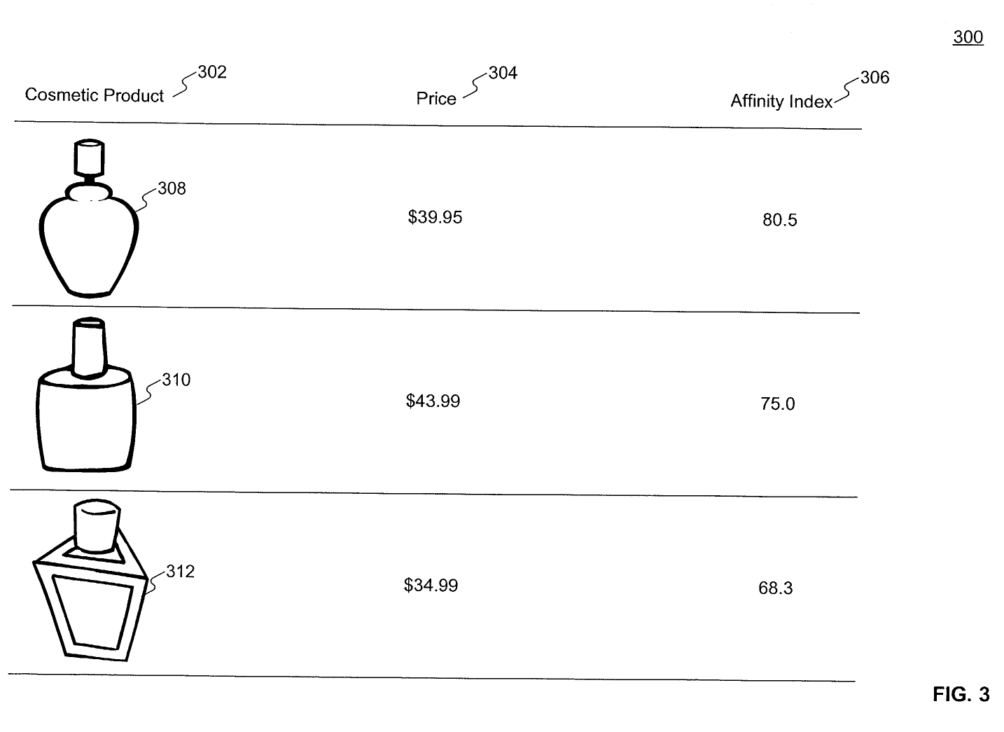

FIG. 3 is an example of results provided to a consumer by a cosmetic service consistent with the present invention. Results 300 may include three columns: cosmetic product 302, indicating specific cosmetic products and possibly including the product name, type, and/or brand along with graphical representations of the products; price 304, indicating a sale price associated with the specific cosmetic products; and affinity index 306, indicating a predicted compatibility level of each cosmetic product with the consumer. The presentation may vary within the scope of the invention. For example, the products may be presented with or without cosmetic product images, pricing information may be omitted, and the form of the affinity index may vary.

FIG. 3 illustrates results 300 for three cosmetic products, 308, 310, and 312. In this example, cosmetic products 308, 310, and 312 may each be different types of moisturizing lotion from brands which may or may not be the same. Cosmetic products 308, 310, and 312 also each have a price and affinity index (e.g., predicted level of compatibility) associated with it. Specifically, product 308 has a price of $39.95 and an affinity index of 80.5. Product 310 has a price of $43.99 and an affinity index of 75.0. Product 312 has a price of $34.99 and an affinity index of 68.3.

Results 300 may also depict a situation where a consumer entered preference information indicating that only the cosmetic category of moisturizing lotions should be considered. The displayed products may be from the same or different brands depending on the consumer's preference information. Also, results 300 may depict a situation where the consumer desired only moisturizing lotions below a price point of $45.00.

The products may be presented in order of descending affinity indices, as reflected in FIG. 3, so that the product (308) with the highest affinity index is listed first, the product (310) with the second highest affinity index is listed second, and so on. A cosmetic product with an affinity index that is greater than the affinity index of another cosmetic product is predicted to be more compatible to the consumer than the other product. As such, cosmetic product 308 is predicted to be more compatible to a consumer than cosmetic product 312. Products may be listed based on other criteria as well, such as ascending price (listing less expensive products first), the consumer's brand preferences, accessibility of products, personal reaction to ingredients, ethical guidelines (e.g., I want a product never tested on animals), country of manufacture, whether product is natural, whether the product is proven effective, whether the product is sold over the counter, or any other criteria that a consumer may wish to consider when making a purchase. The criteria may be automatically chosen or it may be chosen at least in part by the consumer.

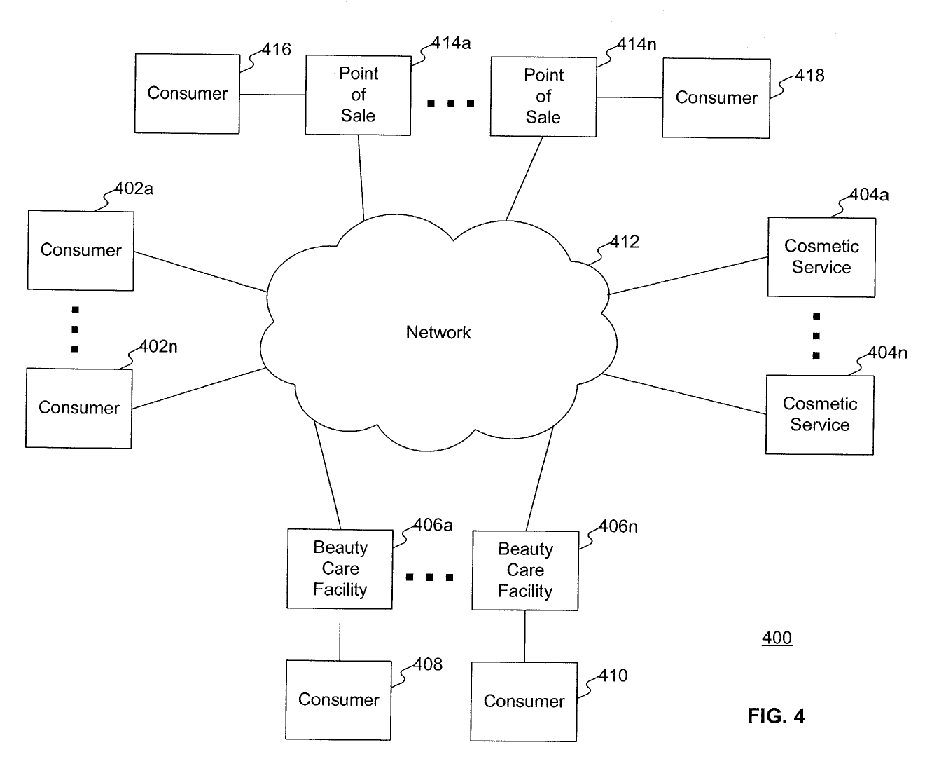

FIG. 4 is a diagram of an exemplary network environment in which features and aspects of the present invention may be implemented. Network environment 400 may include individual consumers 402a-402n, cosmetic services 404a-404n, beauty care facilities 406a-406n, consumers 408, 410, 416 and 418, points of sale 414a-414n, and network 412. The number of components in network environment 400 is exemplary only, and inclusive of various groups of entities, not all of which are required by the invention in its broadest sense. For example, the invention may be implemented without any point of sale entities, without any beauty care facilities, or with only a single cosmetic service.

Individual consumer 402a-402n may be individuals who use a device, such as a computer, Personal Digital Assistant (PDA), or mobile communications equipment, to obtain services offered by a cosmetic service. For example, an individual consumer 402a may provide via network 412, personal information to cosmetic service 404a. Network 412 may be a public network (e.g., the Internet), a private network, a virtual private network, or any wired or wireless mechanism for facilitating communications between two nodes or remote locations. Based on the personal information received from the consumer, the cosmetic service may provide the consumer with information that helps the consumer make a cosmetic purchasing decision.

Personal information may include personal characteristic information and preference information. Personal characteristic information may include physical characteristic information, lifestyle information, and family history information. Physical characteristic information may include information such as age, body size, skin type, skin sun sensitivity, hair type, eye color, facial wrinkles, skin color, and any other information related to physical features. Lifestyle information may include information such as eating habits, exercise habits, exposure to sun, entertainment preferences, fashion preferences, etc. Family history information may include any information related to characteristics of family members, such as whether a consumer's father is bald or grew gray hair at an early age.

Preference information may include information that may affect the consumer product recommendations made to the consumer by the cosmetic service. Such information may include but is not limited to information from a consumer indicative of at least one preferred brand of cosmetic product, information from a consumer indicative of purchase price preferences, information from a consumer indicative of at least one preferred category of cosmetic product, color preferences, fashion preferences, information indicative of a minimum predicted compatibility level, information indicative of a maximum number of cosmetic products to recommend, and any other consumer specific information that may influence cosmetic product recommendations or how those products may be presented. Preference may also include information designating one or more specific cosmetic products to be evaluated for compatibility. In this manner, a consumer that desires to have a particular brand of lipstick (for example) evaluated for compatibility may be provided with predicted compatibility information for the lipstick.

Cosmetic products that are presented may accordingly match preferences provided by the consumer. Examples of categories of cosmetic products include lipstick, lip liner, eyeliner, nail polish, powder, blush, mascara, or other skin treatments, perfume, shampoo, hair colorings or other hair treatments, and any other products for affecting the appearance of the wearer. Categories of cosmetic products may also refer to broader classifications, such as, makeup, skincare, bath products, fragrances, sun protection, etc.

Cosmetic services 404a-404n may be business entities that provide consumers with information that aides the consumers in selecting a cosmetic product. A cosmetic service may include any entity that provides cosmetic information, products, or services to consumers. Information maintained by the cosmetic service may include correlation data between personal characteristics of subjects and compatibility of cosmetic products with individuals having such personal characteristics. A cosmetic service, such as cosmetic service 404a may maintain (e.g., directly store or otherwise provide access to) various items of information relating to subjects. This information may be derived from population surveys, records of interactions with a plurality of individuals, or may be based on experiences of individuals with knowledge of the cosmetic industry. In one such embodiment, cosmetic service 104a may maintain information reflective of the use of a plurality of cosmetic products by subjects, information reflective of personal characteristics of the subjects, and information reflective of a degree of compatibility between at least some of the cosmetic products and the personal characteristics of the subjects.

Cosmetic service 104a may also collect personal characteristic information from a consumer, such as consumer 102a, and then compare the consumer's personal characteristic information with the stored compatibility information relating to the subjects. Based on that comparison, cosmetic service 104a may determine a compatibility level of consumer 102a with various cosmetic products and then provide the consumer with at least one indicator reflective of the consumer's compatibility level with at least one cosmetic product presented to the consumer. A compatibility level, for example, may be reflective of at least one of an aesthetic compatibility with a consumer's appearance and a physical compatibility with a consumer's body chemistry. For example, a compatibility level of a cosmetic product may be relatively high if the product is predicted to aesthetically complement the consumer's physical attributes and is predicted to cause no adverse physical reaction (e.g., no allergies, etc.).

Beauty care facilities 406a-406n may be entities that provide beauty care related services to consumers. For example, a beauty care facility may offer facials, hair treatments, manicures, makeup consultations, and other beauty care related services, as well as offer cosmetic products for sale. A beauty care facility, such as beauty care facility 406a, may also receive personal information from a consumer, such as consumer 408 or 410, which it may forward to a cosmetic service via network 412. The cosmetic service may subsequently determine compatibility levels of the consumer with at least one cosmetic product and provide this information to the beauty care facility for use by the consumer in a manner similar to that explained above.

Points of sale 414a-414n may be entities that sell various cosmetic products to consumers. For example, a point of sale may be a cosmetics counter in a department store. A point of sale, such as point of sale 414a, may also receive personal information from a consumer, such as consumer 416 or 418, which it may forward to a cosmetic service. The cosmetic service may subsequently determine compatibility levels of the consumer with at least one cosmetic product and provide this information to the point of sale for use by the consumer in a manner similar to that explained above.

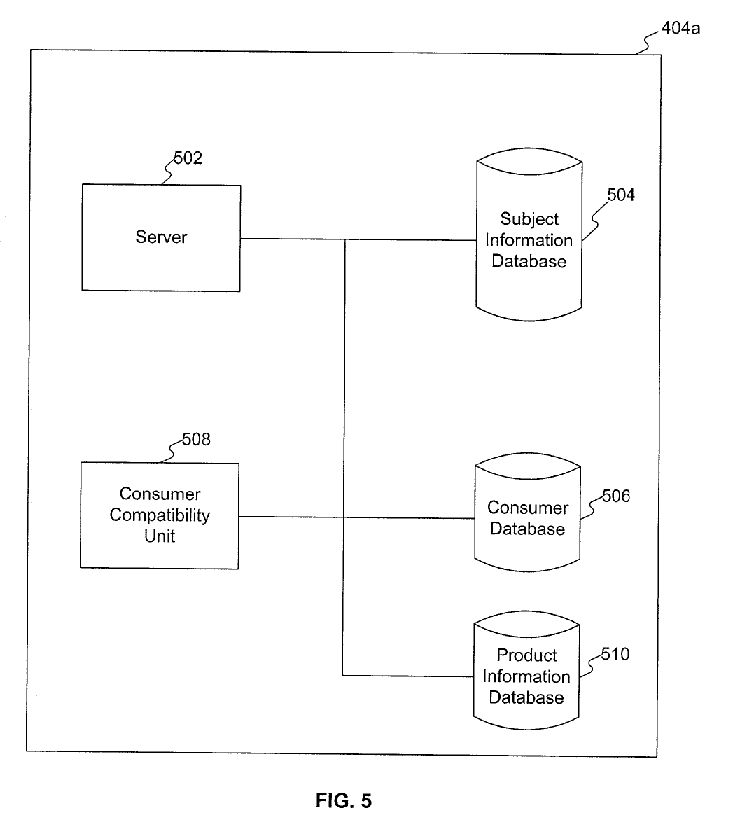

FIG. 5 is an exemplary diagram of cosmetic service 404a, although the other cosmetic services 404b-404n may contain similar components. Cosmetic service 404a may include server 502, subject information database 504, consumer database 506, consumer compatibility unit 508, and product information database 510. The number of components in cosmetic service 404a is exemplary, more or less components may be employed while remaining within the scope and spirit of the invention. In addition, functionality provided by each component may reside in locations remote from each other, with the cosmetic service providing remote access.

Server 502 may connect cosmetic service 404a to a network (such as network 412 of FIG. 4). For example, a consumer (who may be located at home, at a beauty care facility, or at a point of sale) may log on to a web page located at server 502. Alternatively, the consumer may contact server 502 or an employee of cosmetic service 404a using electronic mail, telephone, or regular mail.

After communication has been established, server 502 may request a consumer to provide it with personal information. In a situation where the consumer is a previous customer of cosmetic service 404a, the consumer may provide server 502 with a login/account number and associated password for retrieving previously stored personal information from consumer database 506. Otherwise, the consumer may provide the server with new personal information. Server 502 may then send the received personal information to consumer compatibility unit 508, where the consumer's predicted compatibility with at least one cosmetic product may be computed. Additionally, server 502 may forward the predicted compatibility information to the consumer after receiving that information from consumer compatibility unit 508. While the request for personal information may take the form of queries, the invention in its broadest sense is not so limited. Any mechanism of obtaining personal information about the consumer may fall within the scope of the invention. Thus, personal information may be gleaned by tracking consumer buying or browsing habits, or through cookies or other electronic information gathering mechanisms. In addition, personal information may be gathered through non-electronic mechanisms such as hard copy surveys, personal interviews, or consumer preference polls.

Server 502 may also collect information on at least one subject for storage in subject information database 504. This information may include information reflective of the use of a plurality of cosmetic products by the subjects (cosmetic use information), information reflective of personal characteristics of the subjects, and information reflective of a degree of compatibility between at least some of the cosmetic products and the personal characteristics of the subjects.

Cosmetic use information may refer to an indication of which cosmetic products a subject prefers, as well as how often a subject purchases or uses those cosmetic products. Personal characteristic information of a subject may include information such as physical characteristic information, lifestyle information, family history information, or any other information specific to an individual subject.

Information reflective of a degree of compatibility between at least some of the cosmetic products and the personal characteristics of the subjects (subject compatibility information) may include quantitative data (i.e., data from various tests, such as skin tests) as well as the subject's express perceptions. The extent of compatibility may be computed using an algorithm, and/or it may be a function of ratings provided by subjects. For example, a subject may score self-perception of compatibility with one or more products. This score may then be associated with a set of personal characteristics that correspond to the subject. Alternatively, the subject's compatibility information may be derived by examining the subject's use information and assigning scores to particular products based on the subject's preferences. The subject's set of personal characteristics may then be associated with the products and scores. In addition, those with knowledge in the cosmetic field may provide information on the compatibility of particular characteristics with different types of cosmetic products. For example, cosmetologists may input information on the compatibility of certain facial characteristics with different colors of products, or information on the compatibility of certain moisturizing lotions with people who share a type of allergy.

Subject information database 504 may be populated or updated by information received from server 502. For example, server 502 may prompt a plurality of subjects to enter cosmetic use information, personal characteristic information, and/or subject compatibility information. Prompting may occur, for example, by presenting the subjects with a survey. Upon receiving information from the subjects, server 502 may store the information in its memory and later forward the information to subject information database 504 for storage. Alternatively, subject information may be directly entered into subject database 504.

Consumer database 506 may store information associated with consumers who are new or are preexisting customers of cosmetic service 104a. This information may include personal information and predicted compatibility information corresponding to particular consumers. For example, after receiving personal information from a consumer, server 502 may store the information in its memory and later forward the information to consumer database 506 for storage. Server 502 may also forward the personal information to consumer compatibility unit 508, where predicted compatibility information may be computed. The predicted compatibility information may be sent back to the consumer via server 502. The predicted compatibility information may also be sent to consumer database 506 for storage. Thereafter, whenever that consumer accesses cosmetic service 404a, the consumer may be presented with the previously entered personal information and/or the previously computed predicted compatibility information.

Consumer compatibility unit 508 may receive both collected personal information corresponding to a consumer and compatibility information of subjects maintained in subject information database 504. Consumer compatibility unit 508 may then compare the consumer personal characteristic information from the consumer's personal information with the subject compatibility information, and based on the comparison, determine a predicted compatibility level of the consumer with each of a plurality of cosmetic products. The comparison may include identifying similarities between personal characteristic information received from the consumer and the personal characteristic information from at least one of the subjects. Depending on the consumer's preferences, consumer compatibility unit may also send server 502 information indicative of the predicted compatibility level for at least one cosmetic product for forwarding to the consumer. Consumer compatibility unit 508 may be implemented using one or more processors, at least one of which may include an artificial intelligence engine (e.g., a neural network, fuzzy logic, decision tree, etc.).

Product information database 510 may store information concerning various cosmetic products. For example, this information may comprise at least one of the name, code, category, brand, and price of a plurality of cosmetic products, and any other information that identifies a particular cosmetic product. The information maintained in product information database 510 may be periodically updated by the cosmetic service to include additional cosmetic products, remove existing cosmetic products, change price information, or include/change any other information related to specific cosmetic products.

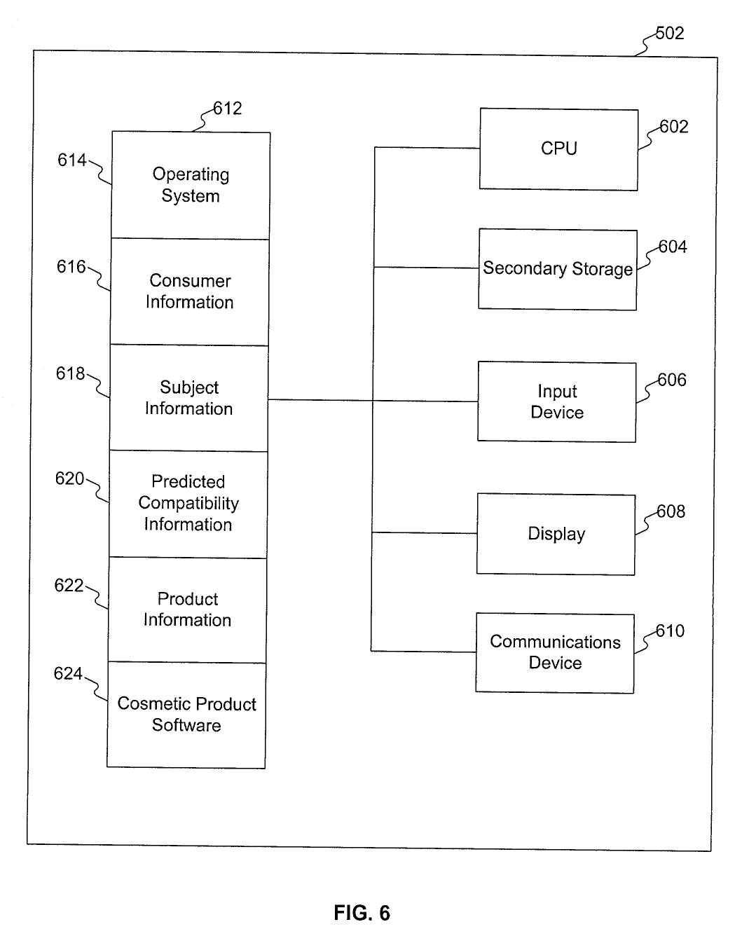

FIG. 6 is an exemplary diagram of server 502 consistent with the present invention. Server 502 may include may include CPU 602, secondary storage 604, input device 606, display 608, communications device 610 and memory 612. Memory 612 may include operating system 614, consumer information 616, subject information 618, predicted compatibility information 620, product information 622, and cosmetic product software 624. In its broadest sense, the invention is not limited to the structure of server 502. In addition, the number of components in server 502 is not limited to what is shown. Additional components may be added, illustrated components may be removed, and alternative server structure and functionality may be provided within the scope and spirit of the invention.

Consumer information 616 may include the types of personal information previously discussed, including both personal characteristic information and preference information.

Subject information 618 may include personal information from subjects and may reflect use of a plurality of cosmetic products by the subjects (cosmetic use information), personal characteristics of the subjects, and a degree of compatibility between at least some of the cosmetic products and the personal characteristics of the subjects (subject compatibility information). Subject information 618 may be received via network 412 from subjects who are not local to the cosmetic service. Thereafter, the subject information 618 may be forwarded to subject information database 504 for storage. Alternatively, subject information 618 may be directly entered in memory 612 by a system administrator of server 502, or it may be loaded into memory 612 from secondary storage 604. For example, cosmetic service 404a may physically or electronically send a survey to a plurality of subjects requesting the subjects to provide various items subject information. Responses to the survey may be compiled and stored in secondary storage 604, where the information may be loaded into memory 612 and forwarded to subject information database 504.

Predicted compatibility information 620 may include information reflective of a predicted compatibility level between a consumer and at least one cosmetic product. This information may be received from consumer compatibility unit 508 and forwarded to the consumer. Once the information is generated, it may be stored for later display to the consumer during another login session. Alternatively, since the system may be dynamic (i.e., information subject to change), during a new session, the system may re-compute previously computed compatibility levels.

Product information 622 may include information concerning various cosmetic products loaded from product information database 510 or secondary storage 604. For example, this information may include at least one of the name, code, category, brand, and price of a plurality of cosmetic products. Product information 622 may be utilized to compile a list of cosmetic products to present to a consumer. The consumer may use such a list to indicate preference information that may limit the predicted compatibility information returned the cosmetic service. So for example, if a consumer is presented with a list including several cosmetic products of varying brands including brand A, consistent with the present invention, the consumer may select the brand A product from the list so that subsequent predicted compatibility information returned to the consumer is only for cosmetic products from brand A. A consumer may select a particular category of cosmetic product in a similar manner.

Cosmetic product software 624 may control the sending of information to and receiving information from a consumer desiring help in making a cosmetic product purchasing decision. For example, when a consumer initiates communication with a cosmetic service, such as cosmetic service 404a, cosmetic product software 624 may send the consumer a request to enter personal information or account/login information associated with previously stored personal information. Cosmetic product software 624 may cause newly entered or previously stored personal information to be forwarded to consumer compatibility unit 508, where the information may be used to help determine predicted compatibility information with respect to at least one cosmetic product. Predicted compatibility information may be sent back to server 502, where cosmetic product software 624 may store it in memory and forward it to the requesting consumer. So for example, once consumer compatibility unit 508 computes predicted compatibility information, it may send the information to server 502. There, cosmetic product software 624 may store the predicted compatibility information in memory 612 and forward it to a consumer for display.

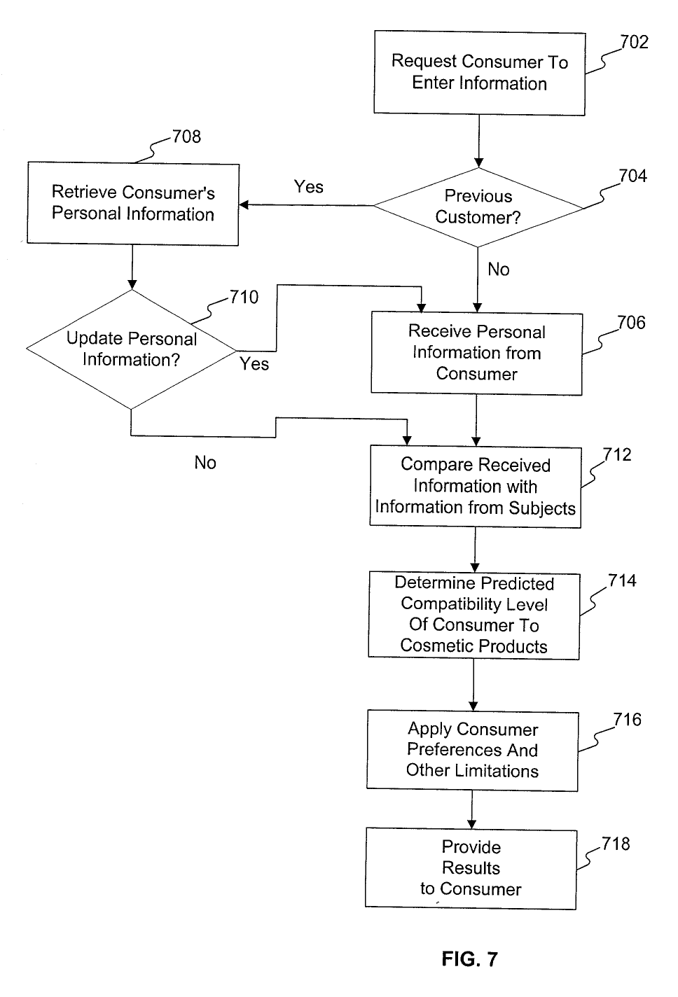

FIG. 7 is another exemplary flowchart of a method for helping a consumer make a cosmetic product purchasing decision consistent with the present invention. A cosmetic service first prompts a consumer to provide personal information (step 702). For example, a consumer located at home, at a beauty facility, or at a point of sale, may access a web page of the cosmetic service. In response, the cosmetic service may present the consumer with a web page having an electronic questionnaire asking the consumer for personal information. Alternatively or additionally, personal information may be obtained by tracking consumer buying or browsing habits. Additionally, the cosmetic service may obtain personal information using other modes of communication, such as electronic mail, regular mail (e.g., physical mail), telephone, or electronic gleaning. The personal information may be stored in memory and then forwarded to a consumer compatibility unit for processing. The personal information may also be stored in a consumer database, where it may be retrieved later. As previously mentioned, personal information may include preference information and personal characteristic information.

In addition to requesting the consumer to provide personal information, the cosmetic service may also inquire whether the consumer is a previous customer of the cosmetic service (step 704). This may be accomplished through a query or a cookie. If the consumer is not a previous customer, then the cosmetic service may have no personal information previously stored for the consumer, and the cosmetic service may proceed to gather personal information as discussed previously. The consumer's personal information may be subsequently received by the cosmetic service (step 706).

If the consumer is a previous customer of the cosmetic service, then the consumer may provide the cosmetic service with a login/account number and associated password (or a cookie) for retrieving previously stored personal information from a consumer database, such as consumer database 506 (step 708). Next, a determination may be made as to whether the consumer desires to update the previously stored personal information (step 710). If an update is desired, the consumer may provide the cosmetic service with the new personal information at step 706. If the consumer does not want to update the personal information, then processing may continue as explained below with reference to step 712.

Upon receiving personal information from the consumer, whether that information is new information or previously stored information, the information may be compared with information collected from a plurality of subjects (step 712). For example, the consumer compatibility unit may receive collected personal characteristic information corresponding to a consumer and compatibility information of subjects maintained in a subject information database. The consumer compatibility unit may then compare the consumer personal characteristic information with the subject compatibility information by identifying similarities between the received consumer personal characteristic information and the personal characteristic information from at least one of the subjects.

Based on the comparing, the consumer compatibility unit may determine a predicted compatibility level of the consumer with each of a set of one or more plurality of cosmetic products (step 714). For example, the consumer compatibility unit may take a set of one or more cosmetic products and access subject compatibility information for each product. By using the identified similarities between the received consumer personal characteristic information and the personal characteristic information from at least one of the subjects, in conjunction with the accessed subject compatibility information, a predicted compatibility level of the consumer with each cosmetic product may be computed.

The set of cosmetic products accessed may be limited by information provided by the consumer. For example, the consumer may desire to only be presented with products from a specific cosmetic product category, from a specific cosmetic product brand, or in a predetermined price range. Additionally, the consumer may desire to only be presented with products that are pre-selected by the consumer. Or perhaps the consumer wants to see both consumer-selected products and a set of alternative cosmetic products.

After the predicted compatibility level of the consumer has been computed for a set of one or more cosmetic products, any additional consumer preferences and other limitations may be applied to the set of cosmetic products (step 716). For example, if the step of determining the predicted compatibility levels was not limited by consumer preference information such as cosmetic product category, cosmetic product brand, or preferred price range, then those limitations may be made in step 716. Moreover, additional preferences and limitations may be applied. These preferences and limitations may include but are not limited to minimum predicted compatibility level, maximum number of cosmetic products to recommend, and any other consumer selected or cosmetic service selected option that may influence what cosmetic products may be recommended to the consumer or how those products may be presented.

Thereafter, the consumer compatibility unit may provide the predicted compatibility level information to a server or employee of the cosmetic service for presentation to the consumer (step 718). The consumer, for example, may be presented with an indication of at least one of the set of cosmetic products. An indicator of the predicted compatibility level information that corresponds to the presented product(s) may also be associated with the presented product. The indicator of the predicted compatibility level information may be presented in numeric form, symbolically, and/or graphically. A code uniquely identifying the presented product or a ranking may also be associated with the presented product. A code may refer to, for example, a UPC (Uniform Product Code), bar code, or other manner of distinguishing one product from another.

An indicator of predicted compatibility level information may be presented to the consumer on one or more screens substantially dedicated to showing results, such as those depicted in FIGS. 3, 8, and 9. Alternatively, an indicator may be presented to the consumer on screens not necessarily dedicated to showing results. As such, the consumer may be provided with compatibility level information as the consumer browses various web pages.

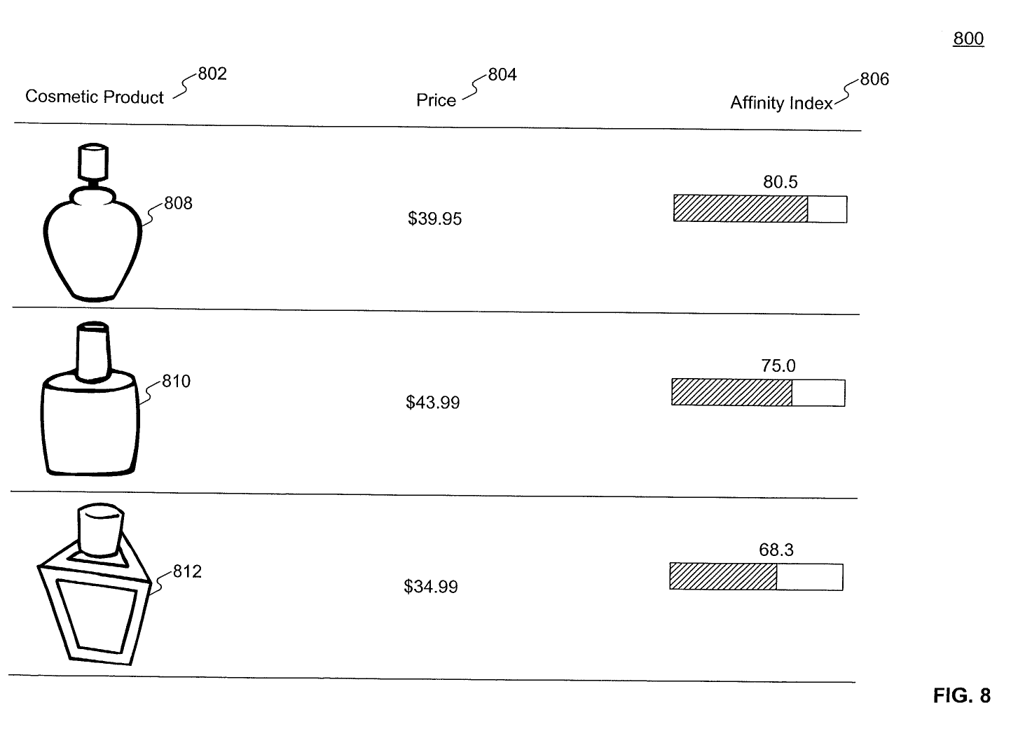

FIG. 8 is another example of results provided to a consumer by a cosmetic service consistent with the present invention. Results 800 includes a cosmetic product column 802, price column 804, and affinity index column 806, similar to the columns shown in FIG. 3. The affinity indices associated with cosmetic products 808, 810, and 812, however, include both a numeric indicator and a graphical indicator.

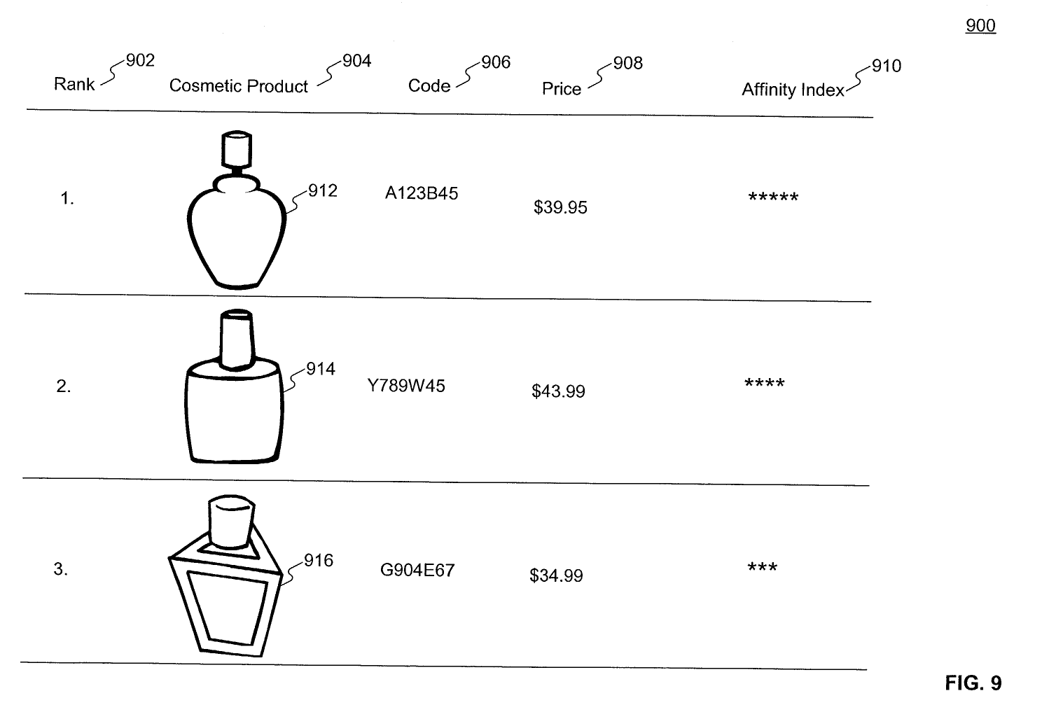

FIG. 9 is yet another example of results provided to a consumer by a cosmetic service consistent with the present invention. Results 900 includes a rank column 902, a cosmetic product column 904, a code column 906, a price column 908, and an affinity index column 910. The affinity indices associated with cosmetic products 912, 914, and 916 include symbolic indicators that permit a consumer to ascertain the relative compatibility of the cosmetic products. In the example set forth in FIG. 9, product 912 is the most compatible, product 914 is the second most compatible, and product 916 is the third most compatible.

The ranks in rank column 902 indicate a numerical order of the relative compatibility of the cosmetic products. Alternatively, cosmetic products may also be ranked at least partially dependent on price.

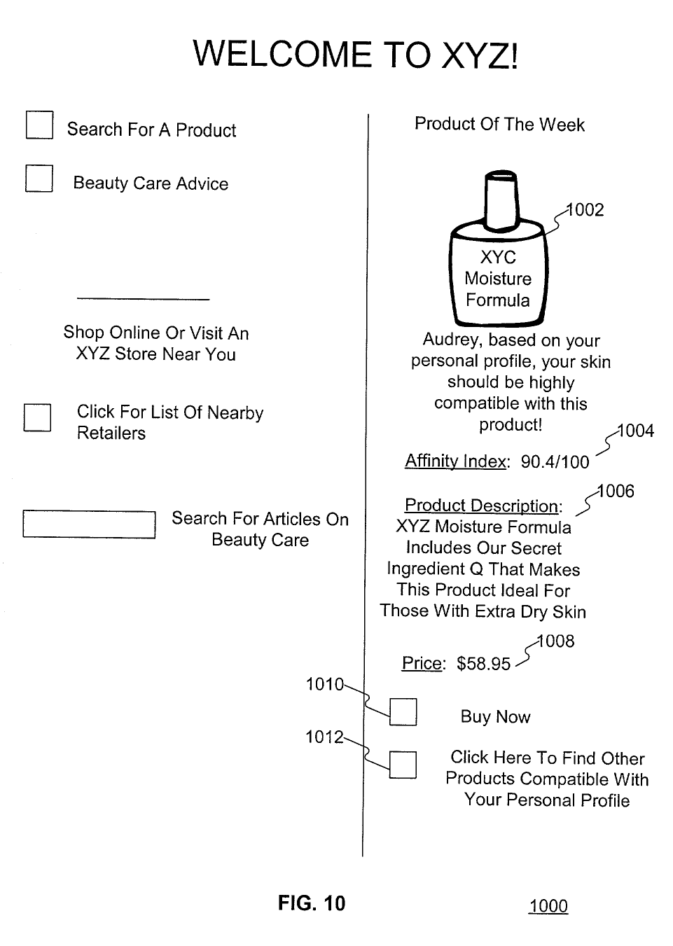

FIG. 10 is an example of a consumer display that includes an indicator of predicted compatibility level information on a screen not necessarily dedicated to showing results. Display 1000 may be a web page from a cosmetic service. Display 1000 shows a cosmetic product 1002, with a corresponding affinity index 1004, product description 1006, and price 1008. Display 1000 also shows button 1010, which may allow a consumer to purchase cosmetic product 1002, and button 1012, which may allow the consumer to cause the cosmetic service to generate a list of alternative cosmetic products that are compatible with the consumer.

Once the system has information on the consumer's personal characteristics, that information may be used to automatically display predicted compatibility information throughout the browsing process whether or not the consumer requests it. So for example, when the consumer logs onto the XYZ web site in FIG. 10, the consumer might not only be presented with the product of the week 1002, but might also be automatically presented with a predicted compatibility (affinity index 1004) with that product. Indeed, every time (or at a merchant-selected time during browsing) a product is displayed, a predicted compatibility level might be displayed with it. This may hold true for cosmetic and non-cosmetic products.

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

Cross-Reference to Concurrently Filed Applications and Global Definitions

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 60/325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Historical Beauty Record, Attorney Docket No. 05725.0975; Identification And Presentation Of Analogous Beauty Case Histories, Attorney Docket No. 05725.0976; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Beauty Advisory System And Method, Attorney Docket No. 05725.0980; Virtual Beauty Consultant, Attorney Docket No. 05725.0981; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0985; Systems And Methods For Providing Beauty Guidance, Attorney Docket No. 05725.0987; Methods And Systems Involving Simulated Application Of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or to at least one of a client-based algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc, are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products-scrubs, rinses, washes, moisturizers, wrinkle removers, exfoliates, toners, cleansers, conditioners, shampoos, cuticle creams, oils, and anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An AI engine may be any system configured to apply knowledge and that can adapt itself and learn to do better in changing environments. Thus, the AI engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the AI engine may learn to adapt to unknown or changing environment for better performance. AI engines may be implemented or provided with a wide variety of components or systems, including one or more of the following: central processing units, co-processors, memories, registers, or other data processing devices and subsystems.

AI engines may be trained based on input such as product information, expert advice, user profile, or data based on sensory perceptions. Using input an AI engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, AI engine may learn to modify its behavior in response to its environment, and obtain knowledge. Knowledge may represent any information upon which AI engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the AI engine or any other component of the system.

“Personal information”, “subject specific information”, “user specific information”, “user profile”, “personal characteristics”, “personal attributes”, “profile information”, and like terms (collectively referred to in this section as “personal information”) may broadly encompass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding client-side methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. A method of helping a consumer make a cosmetic product purchasing decision, the method comprising:
maintaining information reflective of compatibility between cosmetic products and personal characteristics of a plurality of subjects;
collecting personal characteristic information from the consumer;
comparing the consumer's collected personal characteristic information with the maintained compatibility information;
determining, based on the comparing, a compatibility level of the consumer with each of a plurality of the cosmetic products;
presenting to the consumer an indication of at least one of the plurality of cosmetic products; and
associating with the at least one presented product, an indicator of predicted compatibility between the at least one presented product and the consumer.

2. The method of claim 1, wherein the at least one presented product includes a list of cosmetic products.

3. The method of claim 1, wherein the indicators associated with each product are numeric, and wherein the numeric indicators are displayed in a manner permitting the consumer to ascertain relative compatibility of multiple products.

4. The method of claim 1, wherein the indicators associated with each product are symbols, and wherein the symbols are displayed in a manner permitting the consumer to ascertain relative compatibility of multiple products.

5. The method of claim 1, wherein the indicators associated with each product include a graphical representation, and wherein the graphical representations are displayed in a manner permitting the consumer to ascertain relative compatibility of multiple products.

6. The method of claim 2, further comprising prompting the consumer to select at least one category of cosmetic products, and wherein a plurality of listed cosmetic products are selected to fall within the at least one category.

7. The method of claim 1, wherein personal characteristics of the subjects include at least one of physical characteristics, lifestyle information, and family history information.

8. The method of claim 1, wherein personal characteristic information of the consumer includes at least one of physical characteristics, lifestyle information, and family history information.

9. The method of claim 1, wherein the maintained information is generated from at least one survey of cosmetic product users.

10. The method of claim 1, wherein collecting personal characteristic information from the consumer is accomplished through an electronic questionnaire.

11. The method of claim 1, wherein comparing includes identifying similarities between the collected personal information of the consumer and the personal characteristics of at least one of the subjects.

12. The method of claim 11, wherein identifying similarities is accomplished using an artificial intelligence engine.

13. The method of claim 1, wherein at least some of the plurality of the cosmetic products are pre-selected by the consumer.

14. The method of claim 1, wherein none of the plurality of cosmetic products are pre-selected by the consumer.

15. The method of claim 2, wherein the list includes pricing information associated with each product.

16. The method of claim 15, wherein the list is sorted based on at least one of a group of criteria, the group of criteria including level of projected compatibility with the consumer, price, consumer brand preferences, accessibility of products, personal reaction to ingredients, ethical guideline preferences, country of manufacture, whether product is natural, and proven effectiveness.

17. The method of claim 2, performed over a network, wherein presenting includes causing the list to be presented on a display device at a location of the consumer.

18. A method of helping a consumer make a cosmetic purchasing decision, the method comprising:
maintaining information about compatibility between cosmetic products and personal characteristics of a plurality of subjects;
collecting personal characteristic information from the consumer;
comparing the consumer's collected personal characteristic information with the maintained compatibility information;
based on comparing, determining a compatibility level of the consumer with at least one of the cosmetic products;
displaying a representation of the at least one cosmetic product; and
associating with the representation an indicator of compatibility between the at least one cosmetic product and the consumer.

19. The method of claim 18, further comprising presenting to the consumer a menu of cosmetic products, and prompting the consumer to select the at least one cosmetic product from the menu.

20. The method of claim 18, further comprising prompting the consumer to identify a preference for at least one category of cosmetic products, and wherein during comparing, information is processed on a plurality of products within the at least one category and a subset of cosmetic products from the at least one category are selected for display.

21. The method of claim 18, wherein representations of only consumer-selected cosmetic products are displayed.

22. The method of claim 18, wherein alternatives to consumer-selected cosmetic products are displayed.

23. A method of classifying cosmetic products, the method comprising:
maintaining in a data structure information based on the use of a plurality of cosmetic products by a plurality of subjects having varying personal characteristics;
maintaining in the data structure information reflective of at least some of the personal characteristics of the subjects;
maintaining in the data structure information reflective of a degree of compatibility between at least some of the cosmetic products and the personal characteristics of at least some of the subjects;
prompting a consumer to provide personal information reflective of the consumer's own personal characteristics;
comparing the personal information provided by the consumer with the personal characteristics information contained in the data structure; and
causing at least some of the plurality of cosmetic products to be classified by a predicted degree of compatibility with the consumer.

24. The method of claim 23, further comprising displaying to the consumer cosmetics products above a predetermined compatibility classification.

25. The method of claim 23, wherein causing products to be classified includes generating an affinity index for each of the plurality of cosmetic products.

26. The method of claim 23, wherein personal characteristics of the subjects and the consumer include at least one of physical characteristics, lifestyle information, and family history information.

27. The method of claim 23, wherein compatibility includes at least one of aesthetic compatibility with the consumer's appearance and physical compatibility the consumer's biology.

28. A method of prescribing cosmetic products, the method comprising:
maintaining in a data structure information based on the use of a plurality of cosmetic products by a plurality of subjects having varying personal characteristics;
maintaining in the data structure information reflective of at least some of the personal characteristics of the subjects;
maintaining in the data structure information reflective of a degree of compatibility between at least some of the cosmetic products and the personal characteristics of at least some of the subjects;
prompting a consumer to provide personal information reflective of the consumer's own personal characteristics;
comparing the personal information provided by the consumer with the personal characteristics information contained in the data structure; and
causing a display to the consumer of representations of at least some of the plurality of cosmetic products prioritized by degree of predicted compatibility with the consumer.

29. The method of claim 28, wherein the display to the consumer includes a list of products, arranged in order of predicted compatibility.

30. The method of claim 28, wherein the display to the consumer includes one or more of a code, an indicator, or a ranking associated with one or more displayed representations of cosmetic products.

31. The method of claim 28, wherein a ranking and a purchase price are associated with each displayed product representation.

32. The method of claim 28, wherein the plurality of cosmetic products include products of differing brands.

33. The method of claim 32, further comprising causing a display to the consumer of a plurality of recommendations arranged by category.

34. The method of claim 33, wherein the category includes at least one a level of projected compatibility with the consumer, price, consumer brand preferences, accessibility of products, personal reaction to ingredients, ethical guideline preferences, country of manufacture, whether product is natural, and proven effectiveness.

35. The method of claim 28, wherein prompting the consumer to provide personal information includes prompting the consumer to identify a preferred brand of cosmetic product, and wherein at least one of the plurality of recommendations is a recommendation based on the consumer's preferred brand.

36. The method of claim 28, wherein prompting the consumer to provide personal information includes prompting the consumer to identify purchase price preferences, and wherein at least one of the plurality of recommendations is a recommendation based on the consumer's purchase price preferences.

37. A system for helping a consumer select a cosmetic product, the system comprising:
a data structure containing information about personal characteristics of a plurality of test subjects, the data structure further containing information reflective of a degree of compatibility between at least some of the cosmetic products and the physical characteristics of at least some of the subjects;
memory for at least temporarily storing information reflective of the consumer's own personal characteristics; and
a processor for comparing the personal characteristic information provided by the consumer with compatibility information contained in the data structure and for associating with at least one of the plurality of cosmetic products a classifier indicating a degree of compatibility between the at least one product and the consumer.

38. The system of claim 37, wherein personal characteristics of the subjects include at least one of physical characteristics, lifestyle information, and family history information.

39. The system of claim 37, wherein personal characteristic information of the consumer include at least one of physical characteristics, lifestyle information, and family history information.

40. A computer-readable medium containing instructions for causing a computer to perform a method of helping a consumer make a cosmetic product purchasing decision, the method comprising:
maintaining information reflective of compatibility between cosmetic products and personal characteristics of a plurality of subjects;
collecting personal characteristic information from the consumer;
comparing the consumer's collected personal characteristic information with the maintained compatibility information;
based on comparing, determining a compatibility level of the consumer with each of a plurality of the cosmetic products;
presenting to the consumer an indication of at least one of the plurality of cosmetic products; and
associating with the at least one presented product, an indicator of predicted compatibility between the at least one presented product and the consumer.

41. The computer-readable medium of claim 40, wherein the at least one presented product includes a list of cosmetic products.

42. The computer-readable medium of claim 40, wherein the indicators associated with each product are numeric, and wherein the numeric indicators are displayed in a manner permitting the consumer to ascertain relative compatibility of multiple products.

43. The computer-readable medium of claim 40, wherein the indicators associated with each product are symbols, and wherein the symbols are displayed in a manner permitting the consumer to ascertain relative compatibility of multiple products.

44. The computer-readable medium of claim 40, wherein the indicators associated with each product include a graphical representation, and wherein the graphical representations are displayed in a manner permitting the consumer to ascertain relative compatibility of multiple products.

45. The computer-readable medium of claim 41, further comprising prompting the consumer to select at least one category of cosmetic products, and wherein cosmetic products on the list are selected to fall within the at least one category.

46. The computer-readable medium of claim 40, wherein personal characteristics of the subjects include at least one of physical characteristics, lifestyle information, and family history information.

47. The computer-readable medium of claim 40, wherein personal characteristic information of the consumer includes at least one of physical characteristics, lifestyle information, and family history information.

48. The computer-readable medium of claim 40, wherein the maintained information is generated from at least one survey of cosmetic product users.

49. The computer-readable medium of claim 40, wherein collecting personal characteristic information from the consumer is accomplished through an electronic questionnaire.

50. The computer-readable medium of claim 40, wherein comparing includes identifying similarities between the collected personal information of the consumer and the personal characteristics of at least one of the subjects.

51. The computer-readable medium of claim 50, wherein identifying similarities is accomplished using an artificial intelligence engine.

52. The computer-readable medium of claim 40, wherein at least some of the plurality of the cosmetic products are pre-selected by the consumer.

53. The computer-readable medium of claim 40, wherein none of the plurality of cosmetic products are pre-selected by the consumer.

54. The computer-readable medium of claim 41, wherein the list includes pricing information associated with each product.

55. The computer-readable medium of claim 54, wherein the list is sorted from greatest compatibility to least compatibility.

56. A method of helping a consumer make a cosmetic product purchasing decision, the method comprising:
receiving, from a cosmetic service, a request for personal information from the consumer, the personal information including at least one of personal characteristic information and preference information;
sending the personal information to the cosmetic service, wherein the cosmetic service compares the consumer's personal characteristic information with information reflective of compatibility between cosmetic products and personal characteristics of a plurality of subjects, determines a compatibility level of the consumer with each of a plurality of the cosmetic products, and associates with at least one of the cosmetic products, an indicator of predicted compatibility between the at least one cosmetic product and the consumer;
receiving the indicator of predicted compatibility from the cosmetic service; and
displaying the indicator of predicted compatibility with an indication of the at least one cosmetic product.

57. An apparatus for helping a consumer make a cosmetic product purchasing decision, comprising:
a memory including a program that: maintains information reflective of compatibility between cosmetic products and personal characteristics of a plurality of subjects; collects personal characteristic information from the consumer; compares the consumer's collected personal characteristic information with the maintained compatibility information; determines, based on the comparing, a compatibility level of the consumer with each of a plurality of the cosmetic products; presents to the consumer an indication of at least one of the plurality of cosmetic products; and associates with the at least one presented product, an indicator of predicted compatibility between the at least one presented product and the consumer; and
a processor that runs the program.

58. An apparatus for helping a consumer make a cosmetic product purchasing decision, comprising:
means for maintaining information reflective of compatibility between cosmetic products and personal characteristics of a plurality of subjects;
means for collecting personal characteristic information from the consumer;
means for comparing the consumer's collected personal characteristic information with the maintained compatibility information;
means for determining, based on the comparing, a compatibility level of the consumer with each of a plurality of the cosmetic products;
means for presenting to the consumer an indication of at least one of the plurality of cosmetic products; and
means for associating with the at least one presented product, an indicator of predicted compatibility between the at least one presented product and the consumer.

59. An apparatus for helping a consumer make a cosmetic product purchasing decision, comprising:
a memory including a program that: receives, from a cosmetic service, a request for personal information from the consumer, the personal information including at least one of personal characteristic information and preference information; sends the personal information to the cosmetic service, wherein the cosmetic service compares the consumer's personal characteristic information with information reflective of compatibility between cosmetic products and personal characteristics of a plurality of subjects, determines a compatibility level of the consumer with each of a plurality of the cosmetic products, and associates with at least one of the cosmetic products, an indicator of predicted compatibility between the at least one cosmetic product and the consumer; receives the indicator of predicted compatibility from the cosmetic service; and displays the indicator of predicted compatibility with an indication of the at least one cosmetic product; and
a processor that runs the program.
